(19) United States
(12) Patent Application Publication
(10) Pub. No.: US 2008/0228841 A1
(43) Pub. Date: Sep. 18, 2008

(54) INFORMATION PROCESSING SYSTEM, DATA STORAGE ALLOCATION METHOD, AND MANAGEMENT APPARATUS

(76) Inventors: Jun Mizuno, Yokohama (JP); Naoko Ichikawa, Yokohama (JP); Yuichi Taguchi, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/968,226

(22) Filed: Jan. 2, 2008

(30) Foreign Application Priority Data
Mar. 16, 2007 (JP) 2007-069512

(51) Int. Cl. G06F 12/00; G06F 17/30

(52) U.S. Cl. 707/204; 707/205; 707/E17.01; 707/E17.005

(57) ABSTRACT

An information processing system includes: information processing apparatuses, each replicating data sent from a host computer according to redundancy designated by the host computer and creating copy data; a first storage system having volume(s) for storing the data and the copy data; and a management apparatus for managing the information processing apparatuses and the first storage system. The information processing system has: an acquisition unit for acquiring volume replication information indicating whether the volumes are to re replicated in volume(s) in a second storage system; a data storage allocation unit for setting, based on the volume replication information, at least one of the information processing apparatuses as an information processing apparatus for storing the data in a volume to be replicated in the second storage system volume; and a transmission unit for transmitting information concerning the information processing apparatus for storing the data to the information processing apparatuses.

### CROSS-REFERENCES TO RELATED APPLICATIONS

This application relates to and claims priority from Japanese Patent Application No. 2007-069512, filed on Mar. 16, 2007, the entire disclosure of which is incorporated herein by reference.

### BACKGROUND

1. Field of the Invention

The present invention relates to an information processing system, a data storage allocation method, and a management apparatus. The invention is suited for use in, for example, a management apparatus used in an archive system for determining a particular archive node for storing archive data.

2. Description of Related Art

A typical archive system is composed of independently operating host computers and an archive apparatus that reads/writes data in response to commands from the host computers.

The archive apparatus is composed of a computer called an archive node and a storage system that reads/writes data in response to commands from the archive node. The archive apparatus provides a storage area for the host computers.

When the archive node receives a data read/write command from a host computer, it instructs the storage system to read/write the relevant data.

The storage system divides physical disk(s) into several storage areas, and manages them. The storage system provides the storage areas for the archive node in the form of logical volumes. Each logical volume is formed from several segments, each segment being associated with a storage area on the physical disk(s), and data can be read/written based on commands from the host computers.

WO 2005/043323 discloses a distributed archive system in which an archive apparatus forms a cluster from several archive nodes, and archive data is written to those archive nodes according to the redundancy level designated by a host computer, so that the host computer can access the archive data even if some of the archive nodes fail.

Also, JP08-509565 T discloses a remote copy system in which data that has been written to a logical volume provided by a storage apparatus is copied to a logical volume in another storage apparatus located in a remote site.

However, when combining a distributed archive system and a remote copy system in conventional art, and transferring archive data that has been stored based on the distributed archive system to a remote site using the remote copy system, the following problems will occur.

In the distributed archive system, archive data that has been written to the archive system is distributed to several archive nodes that form a cluster. So, in order to transfer all the archive data to a remote site, it would be necessary to provide a remote copy configuration for the logical volumes used by any archive node included in the cluster.

However, if a remote copy configuration is provided for the logical volumes used by any archive node included in the cluster, several copies of the same archive data, which have been made according to the redundancy level designated by the host computer, would all be transferred to the remote site. So, if a host computer designates a redundancy of “N,” the amount of data transferred would be N times greater than the amount of the archive data, resulting in problems like inferior transfer efficiency and archive data overlap in the remote-site storage system.

In light of the above, the present invention aims at proposing an information processing system, a data storage allocation method, and a management apparatus that can considerably improve data processing efficiency.

### SUMMARY

In order to achieve the above object, according to an aspect of the invention, provided is an information processing system including: information processing apparatuses, creating copy data by reproducing the data sent from a host computer according to redundancy designated by the host computer; a first storage system having one or more volumes for storing the data and the copy data; and a management apparatus for managing the information processing apparatuses and the first storage system, wherein: the first storage system has a control unit for controlling volume replication information indicating whether the volumes are to be replicated in one or more volumes in a second storage system; the management apparatus has: an acquisition unit for acquiring the volume replication information controlled in the control unit; a data storage allocation unit for setting, in accordance with the volume replication information acquired by the acquisition unit, at least one of the information processing apparatuses as an information processing apparatus for storing the data in a first volume, from among the first storage system volumes, that is to be replicated in the second storage system volume; and a transmission unit for transmitting information concerning the information processing apparatus for storing the data set by the data storage allocation unit to the information processing apparatuses; and the information processing apparatuses have a data storage unit for storing the data in the first volume, based on the information transmitted from the transmission unit.

According to another aspect of the invention, provided is a data storage allocation method in an information processing system having: information processing apparatuses, creating copy data by reproducing the data sent from a host computer according to redundancy designated by the host computer; a first storage system having one or more volumes for storing the data and the copy data; and a management apparatus for managing the information processing apparatuses and the first storage system, the method including: a first step of acquiring volume replication information indicating whether the volumes are to be replicated in one or more volumes in a second storage system; a second step of setting, in accordance with the volume replication information acquired in the first step, at least one of the information processing apparatuses as an information processing apparatus for storing the data in a first volume, from among the first storage system volumes, that is to be replicated in the second storage system volume; a third step of transmitting information concerning the information processing apparatus for storing the data set in the second step to the information processing apparatuses; and a fourth step of storing the data in the first volume, based on the information transmitted in the third step.

According to another aspect of the invention, provided is a management apparatus for managing information processing apparatuses and a first storage system, creating copy data by reproducing the data sent from a host computer according to redundancy designated by the host computer, and the first storage system having one or more volumes for storing the data and the copy data, the management apparatus including: an acquisition unit for acquiring volume replication information indicating whether the volumes are to re replicated in one or more volumes in a second storage system; a data storage allocation unit for setting, in accordance with the volume replication information acquired by the acquisition unit, at least one of the information processing apparatuses as an information processing apparatus for storing the data in a first volume, from among the first storage system volumes, that is to be replicated in the second storage system volume; and a transmission unit for transmitting information concerning the information processing apparatus for storing the data set by the data storage allocation unit to the information processing apparatuses.

Accordingly, it is possible to achieve the redundancy designated by the host computer, and, at the same time, to store all data stored in the first storage system volumes in the replication destination volumes in the second storage system, without creating any data overlaps. In other words, the information processing system can transfer all data to the second storage system without any overlaps. Accordingly, advantageous effects can be obtained in that, if the host computer designates a redundancy of “N,” the amount of data transferred becomes one Nth smaller, i.e., the transfer efficiency becomes N times better, and in that no archive data overlaps are created in the second storage system.

According to the present invention, it is possible to realize an information processing system, a data storage allocation method, and a management apparatus that can considerably improve data processing efficiency.

Other aspects and advantages of the invention will be apparent from the following description and the appended claims.

### BRIEF DESCRIPTION OF THE DRAWINGS

FIG. 1 is a block diagram illustrating the schematic configuration of an archive system according to an embodiment of the present invention.

FIG. 2 is a block diagram illustrating the schematic configuration of a host computer.

FIG. 3 is a block diagram illustrating the schematic configuration of a storage system.

FIG. 4 is a block diagram illustrating the schematic configuration of an archive node.

FIG. 5 is a block diagram illustrating the schematic configuration of a management server.

FIG. 6 is a schematic view for explaining a volume configuration table.

FIG. 7 is a schematic view for explaining a node group table.

FIG. 8 is a schematic view for explaining a mapping table.

FIG. 9 is a schematic view for explaining an allocation order table.

FIG. 10 is a schematic view for explaining a volume configuration information table.

FIG. 11 is a flowchart showing the processing steps in an allocation program.

FIG. 12 is a flowchart showing the processing steps in a data provision program.

FIG. 13 is a flowchart showing a sequence of processing steps in an embodiment of the invention.

FIG. 14 is a flowchart showing the processing steps in a requirement definition program.

FIG. 15 is a flowchart showing the processing steps in a volume configuration table acquisition program.

FIG. 16 is a flowchart showing the processing steps in a node group table generation program.

FIG. 17 is a flowchart of showing the processing steps in a restoration control program.

FIG. 18 is a flowchart showing the processing steps in a node group table generation program.

### DETAILED DESCRIPTION OF PREFERRED EMBODIMENTS

Embodiments of the present invention will be described in detail below, with reference to the attached drawings.

### (1) First Embodiment

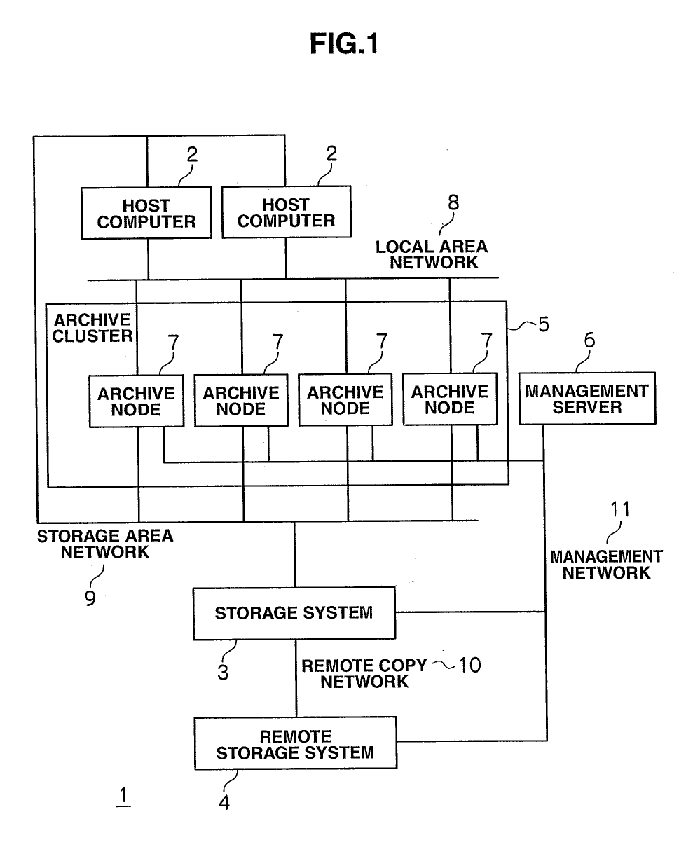

FIG. 1 is a schematic view of an archive system 1 according to a first embodiment of the invention. As shown in FIG. 1, the archive system 1 in the first embodiment includes: one or more host computers 2; a storage system 3; a remote storage system 4; an archive cluster 5; and a management server 6. The archive cluster 5 is composed of one or more archive nodes (information processing apparatuses) 7.

In this embodiment, the host computers 2 are connected to the archive nodes 7 via a local area network (LAN) 8. The host computers 2 are also connected to the storage system 3 and the archive nodes 7 via a storage area network (SAN) 9. Furthermore, the storage system 3 is connected to the remote storage system 4 via a remote copy network 10, and the management server 6 is connected to the storage system 3, the remote storage system 4, and the archive nodes 7 via a management network 11.

The local area network 8, the storage area network 9, the remote copy network 10, and the management network 11 may be the same network.

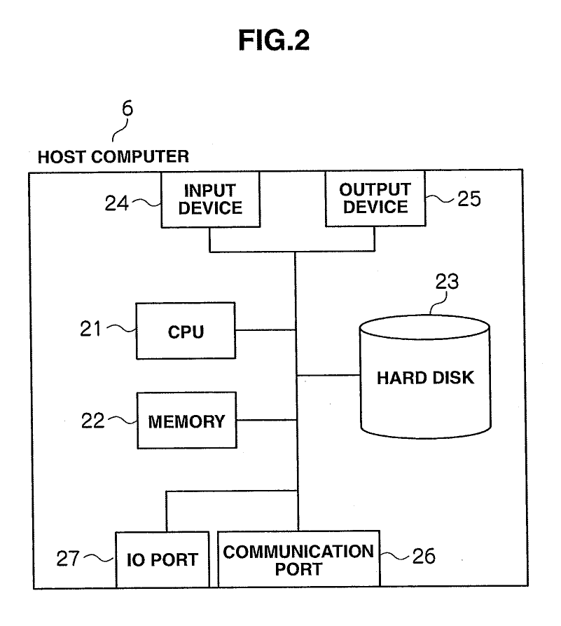

FIG. 2 is a diagram showing the configuration of a host computer 2. The host computer 2 includes: a CPU (Central Processing Unit) 21; memory 22; a hard disk 23; an input device 24; an output device 25; and a communication port 26 for communicating with the archive nodes 7 in the archive cluster 5; and an IO (Input/Output) port 27 for data communication with the storage system 3.

The host computer 2 instructs the archive nodes 7 to store archive data, designating a particular level of redundancy. The archive nodes 7 make the same number of copies of the archive data as the designated redundancy, and store each copy in different archive nodes 7. The redundancy here means the number of copies to be made for particular archive data, designated by the host computer 2 to the archive nodes 7.

The host computer 2 also requests that the archive nodes 7 read archive data, designating a particular archive data ID. The archive nodes 7 return to the host computer 2 the archive data with the designated archive data ID, from among the archive data stored in the archive cluster 5. Note that an archive data ID identifies each piece of archive data.

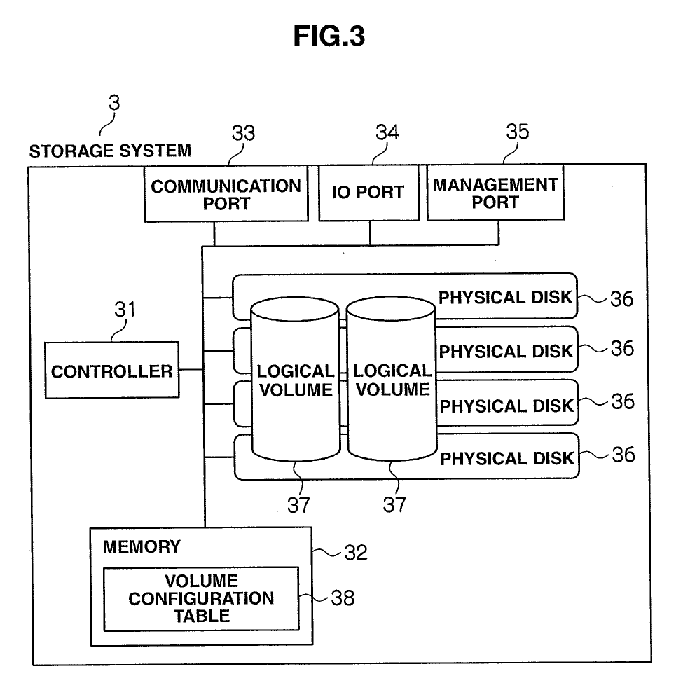

FIG. 3 is a diagram showing the configuration of the storage system 3. The storage system 3 includes: a controller 31 that controls the storage system 3; memory 32; a communication port 33 for archive data communication with the remote storage system 4; an IO port 34 used for communication with the archive nodes 7 in the archive cluster 5; a management port 35 used for communication with the management server 6; and physical disks 36.

The storage system 3 has logically defined volumes (i.e., logical volumes) 37, each being formed from one or more physical disks 36, receives IO requests (e.g. write requests and read requests) targeting the logical volumes 37 from the host computers 2, and sends/receives the archive data related to those requests.

Upon receiving a write request targeting a logical volume 37 that has a remote copy configuration from the host computers 2, the storage system 3 transfers the content to be written to the remote storage system 4, to write that content to a logical volume 37 in the remote storage system 4. The memory 32 includes a volume configuration table 38.

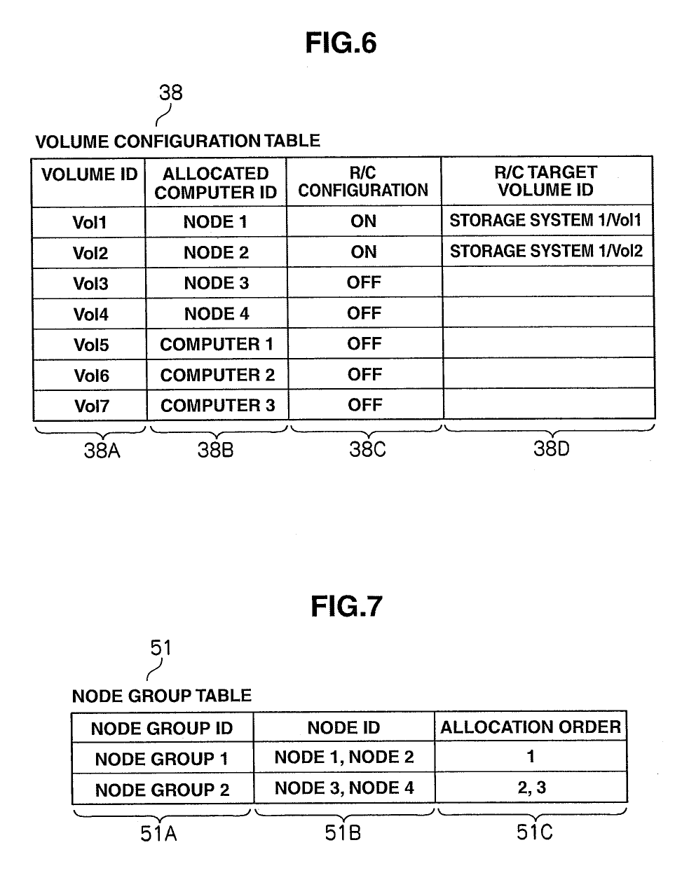

FIG. 6 is a diagram showing the configuration of the volume configuration table 38. The volume configuration table 38 is composed of: a volume ID field 38A for managing a volume ID to identify each logical volume 37 provided in the storage system 3; an allocated computer ID field 38B for managing an allocated computer ID to identify the computer that uses the relevant logical volume 37; an R/C (Remote Copy) configuration field 38C for managing an R/C configuration that shows whether the relevant logical volume 37 is a volume that has a remote copy configuration; and an R/C target volume ID field 38D for managing an R/C target volume ID to identify the logical volume 37 that serves as the remote copy destination.

Upon receiving a request from the management server 6 to acquire the volume configuration table, the storage system 3 sends the content in the volume configuration table 38 to the management server 6.

Meanwhile, the remote storage system 4 has the same configuration as that of the storage system 3, so a diagram showing the configuration of the remote storage system 4 will be omitted.

The remote storage system 4 has logically defined volumes (i.e., logical volumes) 37, each being formed from one or more physical disks 36, receives IO requests targeting the logical volumes 37 from the storage system 3, and sends/receives the archive data related to those requests.

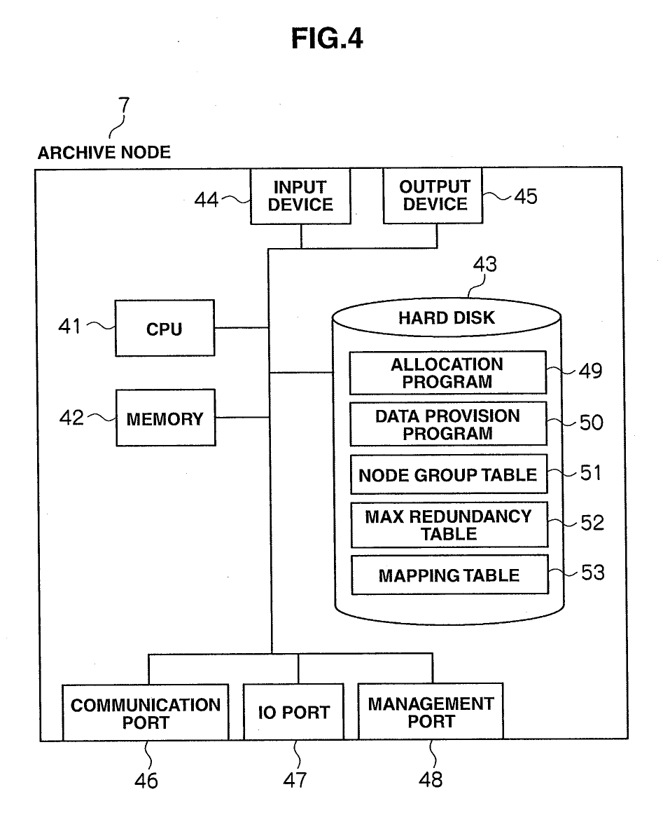

FIG. 4 is a diagram showing the configuration of an archive node 7 in the archive cluster 5. The archive node 7 includes: a CPU 41; memory 42; a hard disk 43; an input device 44; an output device 45; a communication port 46 for archive data communication with the host computers 2; an IO port 47 for data communication with the storage system 3; and a management port 48 for management data communication with the management server 6. The above hardware configuration of the archive node 7 can also be realized using a general-purpose computer or information processing apparatus (personal computer) configured in various other ways.

In the hard disk 43, an allocation program 49 for determining archive node(s) 7 for storing the archive data instructed to be stored by a host computer 2, and a data provision program 50 for providing a host computer 2 with the archive data requested by that host computer 2 are installed. The hard disk 43 also includes: a node group table 51 for managing information used when determining archive node(s) 7 for storing the archive data; a max redundancy table 52 for managing the max redundancy, which is the maximum value of redundancy that the host computers 2 can designate; and a mapping table 53 for mapping the archive nodes 7 as the destination nodes for storing the archive data.

FIG. 7 is a diagram showing the configuration of the node group table 51. The node group table 51 is composed of: a node group ID field 51A for managing a node group ID to identify each node group formed from one or more archive nodes 7; a node ID field 51B for managing the node ID to identify each of the archive nodes 7 in the relevant node group; and an allocation order field 51C for managing the allocation order indicating the order based on which the archive data is to be allocated to the archive node(s) 7 in the relevant node group.

The max redundancy table 52 (not shown in the drawings) contains the max redundancy that is the maximum value of redundancy available to the archive cluster 5, and this max redundancy is, for example, input by an administrator.

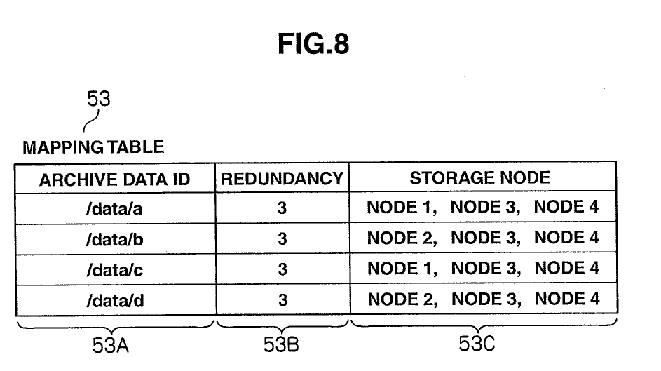

FIG. 8 is a diagram showing the configuration of the mapping table 53. The mapping table 53 is composed of: an archive data ID field 53A for managing an ID to identify archive data stored; a redundancy field 53B for managing the redundancy designated for the relevant archive data stored; and a storage destination node field 53C for managing the node ID(s) for the archive node(s) 7 that serve as the destination node(s) for the relevant archive data stored.

Next, how the archive nodes 7 operate in the first embodiment will be explained below.

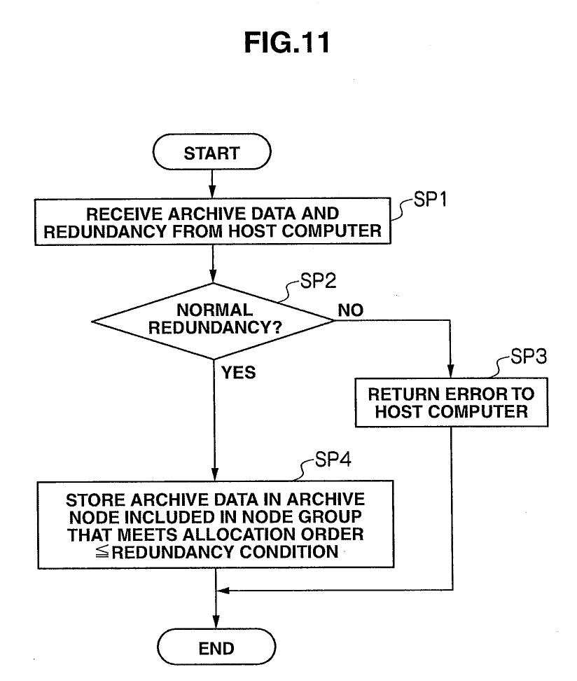

FIG. 11 is a flowchart showing the flow of processing executed in the archive nodes 7 according to the allocation program 49.

In order to clearly show the processing details to be executed by the CPU 41 in the archive node 7 and the CPU 61 in the management server 6 according to each program, the below explanation describes each step of the processing as executed by each program. However, obviously, each step of the processing is actually executed by the corresponding CPU 41 or 61 based on each program.

First, the allocation program 49 receives archive data and its redundancy from a host computer 2 (SP1). The redundancy may be included, for example, in the relevant write request.

The allocation program 49 then checks whether the designated redundancy is normal or not, referring to the max redundancy stored in the max redundancy table 52 (SP2).

If the designated redundancy exceeds the max redundancy (redundancy>max redundancy), the allocation program 49 judges it as being abnormal (SP2: NO), and returns an error to the host computer 2 (SP3), and then the program ends.

On the other hand, if the designated redundancy does not exceed the max redundancy (redundancy≦max redundancy), the allocation program 49 judges it as being normal (SP2: YES), refers to the node group table 51, decides the archive node(s) 7 in which the archive data is to be stored, stores the archive data in the node(s), adds a new record to the mapping table 53, and updates the mapping tables 53 in the other archive nodes 7 constituting the same archive cluster 5 in the same manner (SP4).

The archive data is stored in an archive node 7 belonging to the node group having an allocation order equal to or smaller than the designated redundancy (allocation order≦redundancy). If several archive nodes 7 are included in the node group that meets the “allocation order≦redundancy” condition, the archive data is stored, for example, in the archive node 7 with the smallest capacity already in use.

The above is the explanation of the processing executed in the archive nodes 7 according to the allocation program 49.

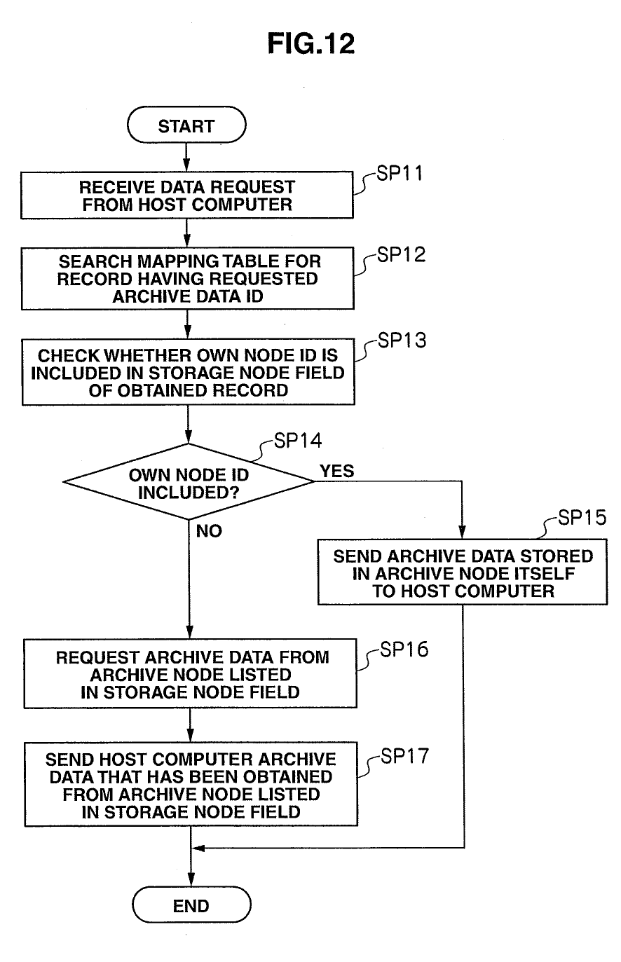

FIG. 12 is a flowchart showing the flow of processing executed in the archive nodes 7 according to the data provision program 50.

First, the data provision program 50 receives a data request including the relevant archive data ID from the host computer 2 (SP11).

The data provision program 50 then searches the mapping table 53 for a record whose value in the archive data ID field 53A matches the archive data ID included in the data request received (SP12).

After that, the data provision program 50 checks the node ID(s) stored in the storage destination node field 53C of the record that has been obtained as a result of the above search in SP12 (SP13).

The data provision program 50 then checks whether or not the storage destination node field 53C includes the node ID for the exact archive node that has received the data request (SP14).

If the storage destination node field 53C includes the node ID for the exact archive node that has received the data request (SP14: YES), the data provision program 50 sends the host computer 2 the archive data stored in the archive node that has received the data request (SP15).

On the other hand, if the storage destination node field 53C does not include the node ID for the exact archive node that has received the data request (SP14: NO), the data provision program 50 requests the archive data from another archive node 7 whose node ID is stored in that storage destination node field 53C, designating the relevant archive data ID (SP16).

The data provision program 50 then receives the archive data in response to the above archive data request, and sends that archive data to the host computer 2 (SP17).

If the storage destination node field 53C stores several node IDs, the data provision program 50 receives the archive data, for example, from the archive node 7 listed first in the field.

The above is the explanation of the processing executed in the archive nodes 7 according to the data provision program 50.

The above is the explanation of how the archive nodes 7 operate in the first embodiment.

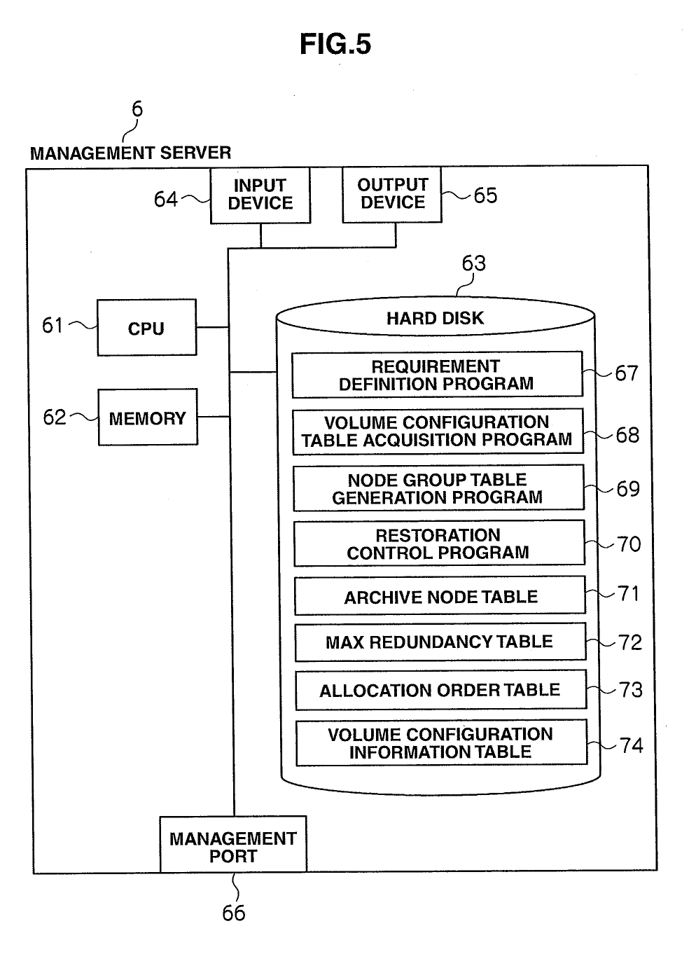

FIG. 5 is a diagram showing the configuration of the management server 6. The management server 6 includes: a CPU 61; memory 62; a hard disk 63; an input device 64; an output device 65; and a management port 66 used for communication with the storage system 3, the remote storage system 4 and the archive nodes 7. This hardware configuration of the management server 6 can also be realized using a general-purpose computer or information processing apparatus (personal computer) configured in various other ways.

In the hard disk 63, a requirement definition program 67 for defining management requirements based on input from an administrator; a volume configuration table acquisition program 68 for acquiring volume configuration information from the storage system 3; a node group table generation program 69 for generating node group information to be provided to the archive nodes 7; and a restoration control program 70 for restoring archive data that has been remote-copied are installed.

The hard disk 63 also includes: an archive node table 71 that holds a list of archive nodes 7 constituting an archive cluster 5, which is input by the administrator; a max redundancy table 72 that holds the max redundancy, which is also input by the administrator; an allocation order table 73 that manages an allocation order calculated in accordance with the max redundancy; and a volume configuration information table 74 that manages information based on the volume configuration table obtained from the storage system 3.

The archive node table 71 holds archive node IDs for identifying archive nodes 7, which are input by the administrator. The max redundancy table 72 holds the max redundancy, which is also input by the administrator.

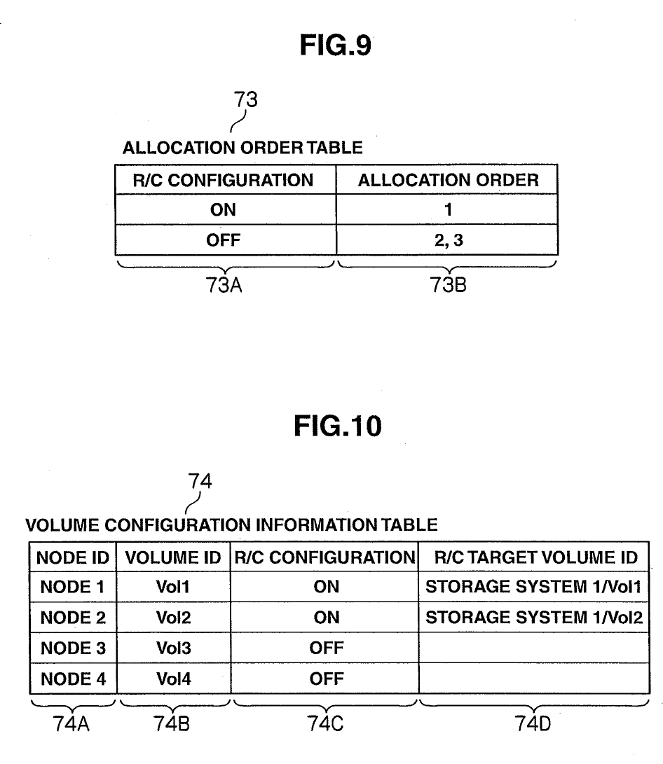

FIG. 9 is a diagram showing the configuration of the allocation order table 73. The allocation order table 73 is composed of an R/C configuration field 73A that manages an R/C configuration used as a basis for deciding whether remote copy should be conducted or not; and an allocation order field 73B that manages the allocation order of the archive nodes 7 when the R/C configuration is “ON” or “OFF.”

FIG. 10 is a diagram showing the configuration of the volume configuration information table 74. The volume configuration information table 74 is composed of: a node ID field 74A that manages a node ID for identifying each archive node 7; a volume ID field 74B that manages a volume ID for identifying the logical volume used by the relevant archive node 7; an R/C configuration field 74C that manages the R/C configuration indicating whether a remote-copy configuration has been set for the relevant logical volume 37; and an R/C target volume ID field 74D that manages an R/C target volume ID for identifying the logical volume 37 to be used as the remote-copy destination.

Next, how the management server 6 operates in this embodiment will be explained below.

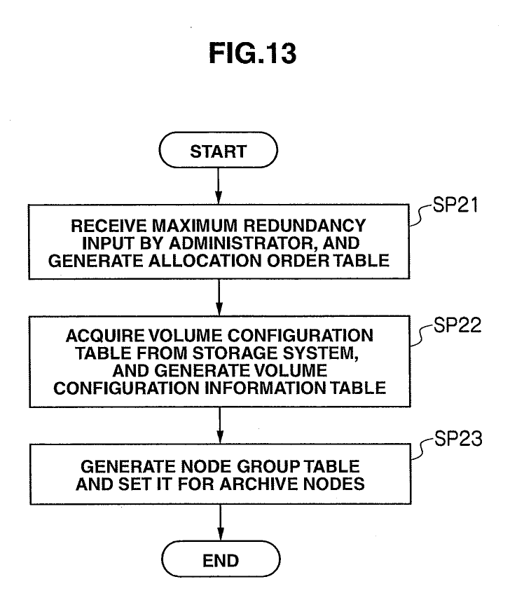

FIG. 13 is a flowchart showing the flow of processing for generating the node group table 51, which is executed in the management server 6.

Based on the requirement definition program 67, the management server 6 receives the max redundancy input by the administrator, and generates the allocation order table 73 (SP21).

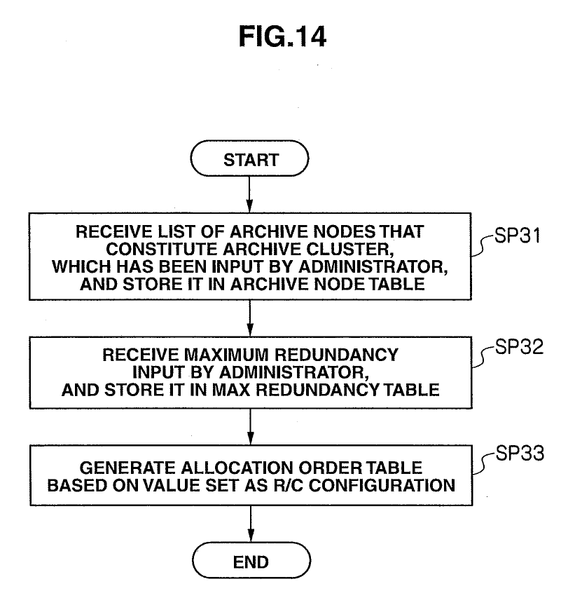

More specific steps in the processing executed based on the requirement definition program 67 (SP21) will be explained below with reference to the flowchart shown in FIG. 14.

The requirement definition program 67 first receives a list of archive nodes 7 that constitute an archive cluster 5, which has been input by the administrator, and stores the list in the archive node table 71 (SP31).

The requirement definition program 67 then receives the max redundancy that has been input by the administrator, and stores it in the max redundancy table 72 (SP32). If the received max redundancy exceeds the number of records for the archive nodes 7 stored in the archive node table 71, the requirement definition program 67 sends an error report to the administrator.

The requirement definition program 67 then generates the allocation order table 73 (SP33). More specifically, the following two records are stored in the allocation order table 73—a record having “ON” in its R/C configuration field 73A, and the number “1” in its allocation order field 73B; and a record having “OFF” in its R/C configuration field 73A, and the numbers from 2 up to the max redundancy in its allocation order field 73B.

The above is the explanation of the specific steps in the processing executed according to the requirement definition program 67 (SP21).

After that, the management server 6 acquires the volume configuration table 38 from the storage system 3, based on the volume configuration table acquisition program 68, and generates the volume configuration information table 74 with reference to that volume configuration table 38 (SP22).

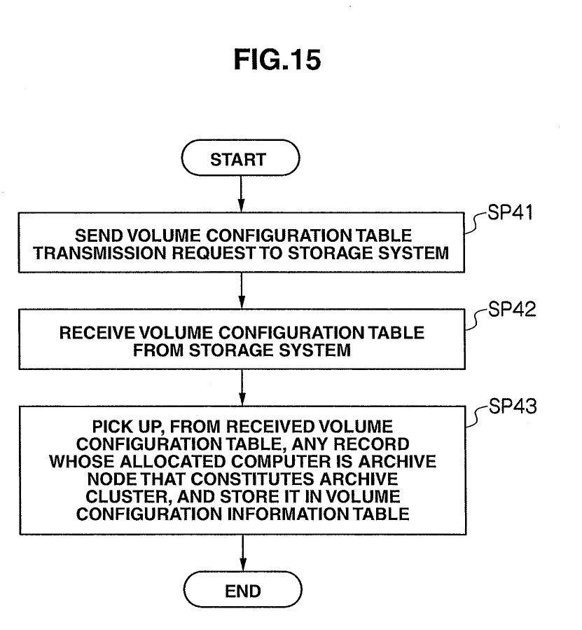

Next, more specific steps in the processing executed based on the volume configuration table acquisition program 68 (SP22) will be explained, with reference to the flowchart shown in FIG. 15.

The volume configuration table acquisition program 68 first sends a volume configuration table transmission request to the storage system 3 (SP41).

Then, the volume configuration table acquisition program 68 receives the volume configuration table 38 from the storage system 3 (SP42).

After that, the volume configuration table acquisition program 68 picks up records, from among the records in the received volume configuration table 38, whose allocated computer ID field 38B stores the ID for the archive node(s) 7 contained in the archive node table 71, and stores the picked up records in the volume configuration information table 74, (SP43).

The relevant allocated computer ID (node ID) stored in the volume configuration table 38 is stored in the node ID field 74A in the volume configuration information table 74. The relevant logical volume ID for a logical volume 37 stored in the volume configuration table 38 is stored in the volume ID field 74B. The relevant R/C configuration (“ON” or “OFF”) stored in the volume configuration table 38 is stored in the R/C configuration field 74C. The relevant R/C target volume ID stored in the volume configuration table 38 is stored in the R/C target volume field 74D.

The above is the explanation of the specific steps in the processing executed based on the volume configuration table acquisition program 68 (SP22).

After the above process, the management server 6 generates the node group table 51 based on the node group table generation program 69, and provides it to the archive nodes 7 (SP23).

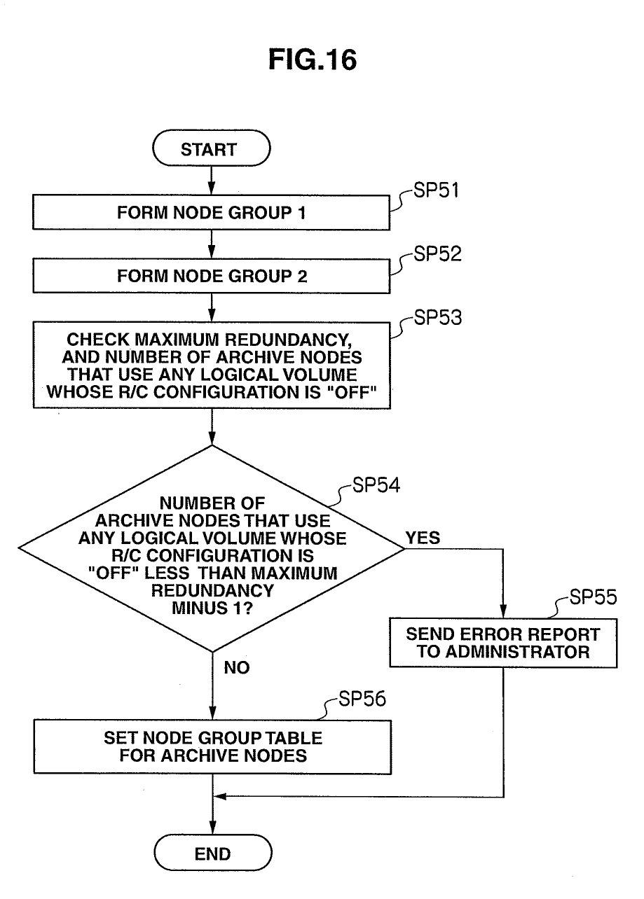

Next, more specific steps in the processing executed based on the node group table generation program 69 (SP23) will be explained, with reference to the flowchart shown in FIG. 16.

First, the node group table generation program 69 refers to the volume configuration information table 74, forms node group 1 from the archive nodes 7 that use any logical volume whose R/C configuration field 74C is “ON,” and stores the node IDs for the archive nodes 7 that constitute node group 1 in the node ID field 50B. The node group table generation program 69 also refers to the allocation order table 73, finds the allocation order stored in the allocation order field 73B of the record whose R/C configuration field 73A is “ON,” and sets that allocation order as the allocation order for node group 1 (SP51).

The node group table generation program 69 then refers to the volume configuration information table 74, forms node group 2 from the archive nodes 7 that use any logical volume 37 whose R/C configuration field 74C is “OFF,” and stores the node IDs for the archive nodes 7 that constitute node group 2 in the node ID field 50B. The node group table generation program 69 also refers to the allocation order table 73, finds the allocation order stored in the allocation order field 73B of the record whose R/C configuration field 73A is “OFF,” and sets that allocation order as the allocation order for node group 2 (SP52).

The node group table generation program 69 then checks the number of the archive nodes 7 that use any logical volume whose R/C configuration stored in the R/C configuration field 74C in the volume configuration information table 74 is “OFF,” and the max redundancy stored in the max redundancy table 72 (SP53).

Then, the node group table generation program 69 checks whether the number of the archive nodes 7 that use any logical volume whose R/C configuration is “OFF” is less than (the max redundancy−1) (the max redundancy minus one) (SP54).

If the number of the archive nodes 7 that use any logical volume whose R/C configuration is “OFF” is less than (the max redundancy−1) (SP54: YES), the node group table generation program 69 sends an error report to the administrator (SP55), and the program ends.

On the other hand, if the number of the archive nodes 7 that use any logical volume whose R/C configuration is “OFF” is equal to or greater than (the max redundancy−1) (SP54: NO), the node group table generation program 69 sends the node group table 51 to the archive nodes 7 to store and set it (SP56).

The above is the explanation of the specific steps in the processing executed based on the node group table generation program 69 (SP23).

This embodiment employs a configuration where the management server 6 receives the max redundancy and the list of archive nodes that constitute the archive cluster 5 from the administrator. However, another configuration may be used where the management server 6 reads the max redundancy information and the archive node list information stored in a setting file.

The above is the explanation of the processing executed in the management server 6 to generate the node group table 51.

Next, restoration processing (data restoration processing) executed in the management server 6 will be explained.

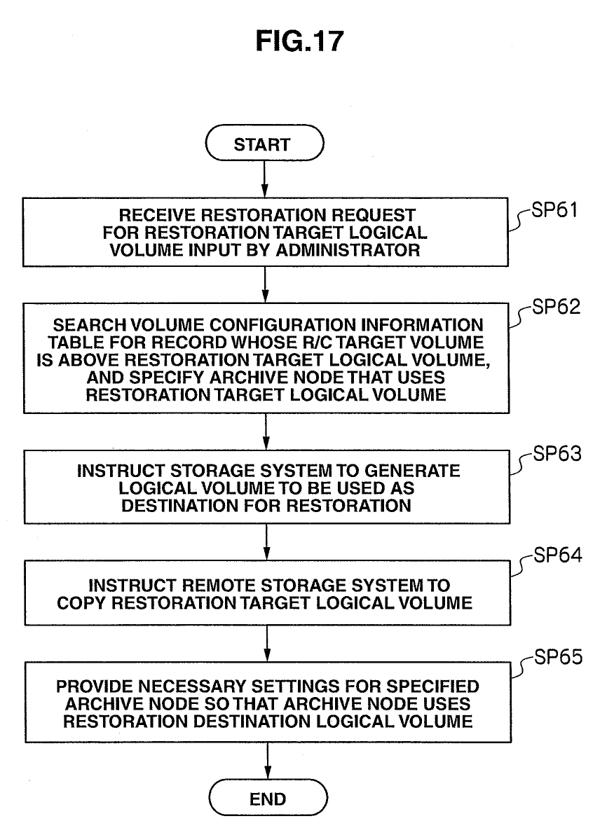

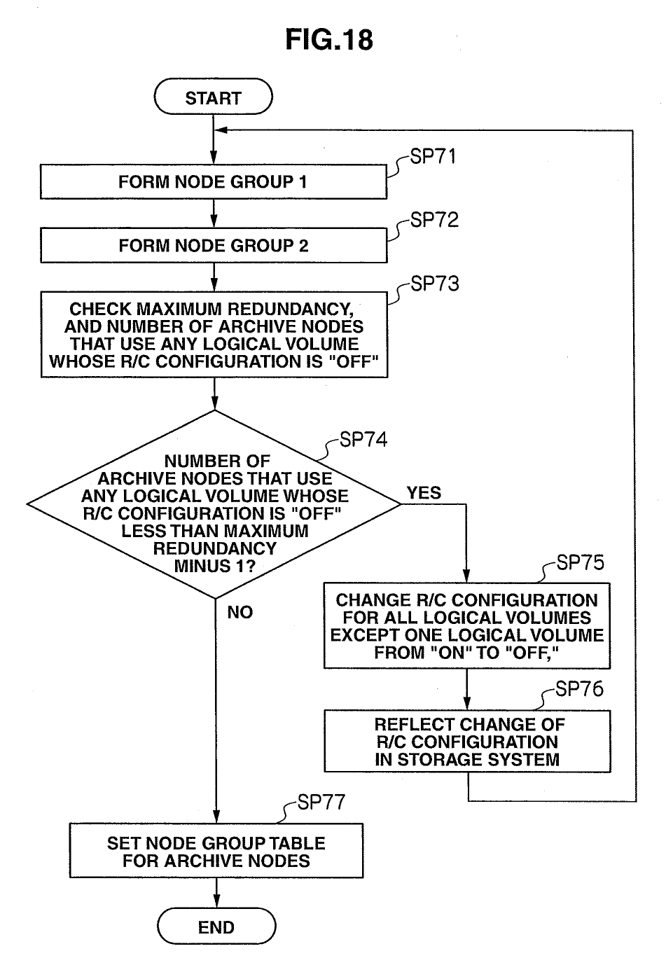

FIG. 17 is a flowchart showing the flow of processing executed in the management server 6 based on the restoration control program 70.

The restoration control program 70 first receives a restoration request for a particular restoration target logical volume 37, which has been input by the administrator (SP61).

The restoration control program 70 then refers to the volume configuration information table 74, searches for a record whose R/C target volume ID field 74D stores an R/C target volume ID that matches the logical volume ID for the above restoration target logical volume 37 designated by the administrator, and specifies the archive node 7 that uses the restoration target logical volume 37, by referring to the node ID stored in the node ID field 74A of the above record (SP62).

Then, the restoration control program 70 instructs the storage system 3 to generate a logical volume 37 to be used as the destination for restoration (SP63).

Next, the restoration control program 70 instructs the remote storage system 4 to copy the content in the restoration target logical volume 37 to the restoration destination logical volume 37 (SP64).

After that, the restoration control program 70 provides the necessary settings for the above specified archive node 7, so that the archive node 7 can use the restoration destination logical volume 37, to which the restoration target data has been copied from the remote storage system 4, as a logical volume 37 for storing archive data (as the restoration target logical volume 37) (SP65).

The above is the explanation of the restoration processing executed in the management server 6.

The above is the explanation of how the management server 6 operates in the first embodiment.

This embodiment employs a configuration where the management server 6 and the archive nodes 7 run on different apparatuses. However, another configuration may be used where a program for executing the processing executed in the management server 6 is installed on the hard disk 43 of the archive nodes 7.

The archive system 1 according to this embodiment acquires the volume configuration table 38 from the storage system 3, and based on that volume configuration table 38, generates the node group table 51 for determining a particular archive node 7 as a node for storing archive data sent from the host computer 2 in a logical volume 37 having a remote-copy configuration, and sends the generated node group table 51 to the archive nodes 7 to store and set it.

In other words, taking the configuration of each logical volume 37 used by the archive nodes 7 constituting the archive cluster 5 into consideration, the archive system 1 forms a node group, i.e., a collection of archive nodes 7, so that archive data is stored with no overlaps, and determines specific archive node(s) 7 for storing archive data, in accordance with the redundancy designated by the host computer 2.

Accordingly, it is possible to meet the redundancy requirements designated by the host computer 2, and, at the same time, to store all archive data in any logical volume 37 having a remote-copy configuration, without creating any overlaps. Because the archive system 1 can transfer all archive data to the remote storage system 4 without any overlaps, advantageous effects can be obtained in that if the host computer 2 designates a redundancy of “N,” the amount of data transferred becomes one Nth smaller, i.e., the transfer efficiency becomes N times better, and in that no archive data overlaps are created in the storage system in a remote site.

### (2) Second Embodiment

In a second embodiment, in the situation where an archive cluster 5 is composed of a substantial number of archive nodes 7, an archive system 1 enables a host computer 2 to designate a redundancy exceeding (the number of the archive nodes 7 that use any logical volume 37 whose R/C configuration is “OFF”+1).

The second embodiment of the invention will be explained below with reference to the drawings.

The configuration of the archive system 1 in the second embodiment is almost the same as that of the archive system 1 in the first embodiment, but the operation of the node group table generation program 69, which is installed on the hard disk 63 of the management server 6, differs from the first embodiment.

FIG. 16 is a flowchart showing the flow of processing executed in the management server 6 in this embodiment, based on the node group table generation program 69.

The node group table generation program 69 first forms node group 1, in the same way as in the first embodiment (SP71).

Then, the node group table generation program 69 forms node group 2, in the same way as in the first embodiment (SP72).

After that, like in the first embodiment, the node group table generation program 69 checks the number of the archive nodes 7 that use any logical volume whose R/C configuration stored in the R/C configuration field 74C in the volume configuration information table 74 is “OFF”, and the max redundancy stored in the max redundancy table 72 (SP73).

The node group table generation program 69 then checks whether the number of the archive nodes 7 that use any logical volume whose R/C configuration is “OFF” is less than (the max redundancy−1) (the max redundancy minus one) (SP74).

If the number of the archive nodes 7 that use any logical volume whose R/C configuration is “OFF” is less than (the max redundancy−1) (SP74: YES), the node group table generation program 69 changes the R/C configuration from “ON” to “OFF,” for the same number of logical volumes 37 as (the max redundancy−1—(the number of the archive nodes 7 that use any logical volume whose R/C configuration is “OFF”)) (SP75). In other words, the node group table generation program 69 changes the R/C configuration from “ON” to “OFF” in the volume configuration information table 74, for all logical volume IDs except one logical volume ID.

After that, the node group table generation program 69 sends a request for the change of an R/C configuration from “ON” to “OFF” to the storage system 3, so that the above change can be reflected in the storage system 3 (SP76), and then returns to the step to generate node group 1 (SP71).

If the number of the archive nodes 7 that use any logical volume whose R/C configuration is “OFF” is equal to or greater than (the max redundancy−1) (SP74: NO), the node group table generation program 69 sends the node group table 51 to the archive nodes 7 to store and set it (SP77).

The above is the explanation of the processing executed in the management server 6 in this embodiment, based on the node group table generation program 69.

In the second embodiment, if the number of the archive nodes 7 that use any logical volume whose R/C configuration is “OFF” is less than (the max redundancy−1), the archive system 1 changes the R/C configuration from “ON” to “OFF,” for all logical volume IDs except one logical volume ID.

As a result, in addition to the advantageous effects brought about by the first embodiment, an additional effect can be obtained, i.e., the host computer 2 can designate any value of redundancy within the number of the archive nodes 7 that constitute the archive cluster 5.

The present invention can be widely applied in information processing systems that determine the destination for storing various types of data other than archive data.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An information processing system comprising:
information processing apparatuses, each replicating data sent from a host computer according to redundancy designated by the host computer and creating copy data;
a first storage system having one or more volumes for storing the data and the copy data; and
a management apparatus for managing the information processing apparatuses and the first storage system,
wherein:
the first storage system comprises a control unit for controlling volume replication information indicating whether the volumes are to be replicated in one or more volumes in a second storage system;
the management apparatus comprises: an acquisition unit for acquiring the volume replication information controlled in the control unit; a data storage allocation unit for setting, in accordance with the volume replication information acquired by the acquisition unit, at least one of the information processing apparatuses as an information processing apparatus for storing the data in a first volume, from among the first storage system volumes, that is to be replicated in the second storage system volume; and a transmission unit for transmitting information concerning the information processing apparatus for storing the data set by the data storage allocation unit to the information processing apparatuses; and
the information processing apparatuses comprise a data storage unit for storing the data in the first volume, based on the information transmitted from the transmission unit.

2. The information processing system according to claim 1,
wherein the data storage allocation unit groups the information processing apparatuses associated with the volumes in accordance with the volume replication information, and establishes an allocation order for each group, the allocation order showing an order for storing the data and the copy data.

3. The information processing system according to claim 2,
wherein the data storage allocation unit establishes a value of 1 as the allocation order for the group of the information processing apparatuses associated with any first volume, and establishes values of from 2 to the max redundancy input in advance by an administrator as the allocation order for the group of the information processing apparatuses associated with any second volume that is a volume other than a first volume from among the first storage system volumes.

4. The information processing system according to claim 3,
wherein the data storage allocation unit performs allocation based on the allocation order so that the data is stored in the first volume and the copy data is stored in the second volume.

5. The information processing system according to claim 4,
wherein, if the number of the information processing apparatuses associated with any second volume is less than the max redundancy minus 1, the data storage allocation unit sets the number of the information processing apparatuses associated with any first volume to one.

6. The information processing system according to claim 1,
wherein the management apparatus further comprises a restoration unit for realizing restoration in the first storage system using the second storage system volume, the restoration unit instructing the first storage system to generate a restoration destination volume, also instructing the second storage system to copy the content of a restoration target volume to the restoration destination volume, and setting the first storage system so that the first storage system uses the restoration destination volume as the restoration target volume.

7. A data storage allocation method in an information processing system having: information processing apparatuses, each replicating data sent from a host computer according to redundancy designated by the host computer and creating copy data; a first storage system having one or more volumes for storing the data and the copy data; and a management apparatus for managing the information processing apparatuses and the first storage system, the method comprising:
a first step of acquiring volume replication information indicating whether the volumes are to be replicated in one or more volumes in a second storage system;
a second step of setting, in accordance with the volume replication information acquired in the first step, at least one of the information processing apparatuses as an information processing apparatus for storing the data in a first volume, from among the first storage system volumes, that is to be replicated in the second storage system volume;
a third step of transmitting information concerning the information processing apparatus for storing the data set in the second step to the information processing apparatuses; and
a fourth step of storing the data in the first volume, based on the information transmitted in the third step.

8. The data storage allocation method according to claim 7,
wherein the second step comprises grouping the information processing apparatuses associated with the volumes in accordance with the volume replication information, and establishing an allocation order for each group, the allocation order showing an order for storing the data and the copy data.

9. The data storage allocation method according to claim 8,
wherein the second step comprises establishing a value of 1 as the allocation order for the group of the information processing apparatuses associated with any first volume, and establishing values of from 2 to the max redundancy input in advance by an administrator as the allocation order for the group of the information processing apparatuses associated with any second volume that is a volume other than a first volume from among the first storage system volumes.

10. The data storage allocation method according to claim 9,
wherein the second step comprises performing allocation based on the allocation order so that the data is stored in the first volume and the copy data is stored in the second volume.

11. The data storage allocation method according to claim 10,
wherein the second step comprises setting the number of the information processing apparatuses associated with any first volume to one, if the number of the information processing apparatuses associated with any second volume is less than the max redundancy minus 1.

12. The data storage allocation method according to claim 7, further comprising a fifth step of realizing restoration in the first storage system using the second storage system volume,
wherein the fifth step comprises instructing the first storage system to generate a restoration destination volume, also instructing the second storage system to copy the content of a restoration target volume to the restoration destination volume, and setting the first storage system so that the first storage system uses the restoration destination volume as the restoration target volume.

13. A management apparatus for managing information processing apparatuses and a first storage system, each information processing apparatus replicating data sent from a host computer according to redundancy designated by the host computer and creating copy data, and the first storage system having one or more volumes for storing the data and the copy data, the management apparatus comprising:
an acquisition unit for acquiring volume replication information indicating whether the volumes are to re replicated in one or more volumes in a second storage system;
a data storage allocation unit for setting, in accordance with the volume replication information acquired by the acquisition unit, at least one of the information processing apparatuses as an information processing apparatus for storing the data in a first volume, from among the first storage system volumes, that is to be replicated in the second storage system volume; and
a transmission unit for transmitting information concerning the information processing apparatus for storing the data set by the data storage allocation unit to the information processing apparatuses.

14. The management apparatus according to claim 13,
wherein the data storage allocation unit groups the information processing apparatuses associated with the volumes in accordance with the volume replication information, and establishes an allocation order for each group, the allocation order showing an order for storing the data and the copy data.

15. The management apparatus according to claim 14,
wherein the data storage allocation unit establishes a value of 1 as the allocation order for the group of the information processing apparatuses associated with any first volume, and establishes values of from 2 to the max redundancy input in advance by an administrator as the allocation order for the group of the information processing apparatuses associated with any second volume that is a volume other than a first volume from among the first storage system volumes.

16. The management apparatus according to claim 15,
wherein the data storage allocation unit performs allocation based on the allocation order so that the data is stored in the first volume and the copy data is stored in the second volume.

17. The management apparatus according to claim 16,
wherein, if the number of the information processing apparatuses associated with any second volume is less than the max redundancy minus 1, the data storage allocation unit sets the number of the information processing apparatuses associated with any first volume to one.

18. The management apparatus according to claim 13, further comprising a restoration unit for realizing restoration in the first storage system using the second storage system volume,
wherein the restoration unit instructs the first storage system to generate a restoration destination volume, also instructs the second storage system to copy the content of a restoration target volume to the restoration destination volume, and sets the first storage system so that the first storage system uses the restoration destination volume as the restoration target volume.
